(19) United States
(12) Patent Application Publication
(10) Pub. No.: US 2012/0061453 A1
(43) Pub. Date: Mar. 15, 2012

(54) Method for Producing Tailor-Made Sheet Strips

(75) Inventors: Hans-Peter Vogt, Nachrodt-Wiblingwerde (DE); Albrecht Krüger-Eppstein, Stuttgart (DE)

(73) Assignee: THYSSENKRUPP TAILORED BLANKS GMBH, Duisburg (DE)

(21) Appl. No.: 13/132,380

(22) PCT Filed: Nov. 16, 2009
(86) PCT No.: PCT/EP2009/065187

§ 371 Date: Oct. 7, 2011

(30) Foreign Application Priority Data
Dec. 5, 2008 (DE) 10 2008 060 467.4

(51) Int. Cl. B23K 31/02; B23K 28/00

(52) U.S. Cl. 228/160; 228/199; 228/176

(57) ABSTRACT

A method for producing tailor-made sheet metal strips, in particular steel strips, in which at least two sheet metal strips of different material quality and/or sheet metal thickness are welded to one another along the longitudinal edge in a continuous process. In order for the sheet metal strips produced by such a method to exhibit a relatively high level of weld seam strength, uncoated sheet metal strips are used in accordance with the invention as sheet metal strips to be welded. The tailor-made sheet metal strip formed of the uncoated sheet metal strips as a result of welding is then coated.

The invention relates to a method for producing tailor-made sheet metal strips, in particular steel strips, in which at least two sheet metal strips of different material quality and/or sheet metal thickness are welded to one another along the longitudinal edge in a continuous process.

A method of this type is known for example from EP 0 438 612 B1. It is used to produce so-called “tailored strips”, i.e. tailor-made sheet metal strips, in particular tailor-made steel strips. In order to produce tailored strips a plurality of slit strips, normally two or three slit strips, of different material quality and/or sheet metal thickness which are each rolled up in the form of a coil are unrolled and welded to one another along the longitudinal edge by means of a laser in a continuous process. Tailored strips are used very successfully in light-gauge steel construction, wherein they are adapted from the outset to the stress conditions present in the finished component (end product). Tailored strips can advantageously be machined in follow-on composite tools, in particular shaped and trimmed.

The slit strips used to produce tailored strips are generally provided on one or both sides with a coating, for example with a zinc layer or an oil layer, in order to protect the respective slit strip against corrosion. In practice it has been found that premature and undefined failure of the weld seam occurs when the tailor-made sheet metal strips thus produced are shaped or subjected to high stresses.

The problem addressed by the present invention is to improve a method of the above-mentioned type to the effect that the sheet metal strips produced by the method exhibit a relatively high level of weld seam strength.

This problem is solved by a method having the features of claim 1.

In the method according to the invention uncoated sheet metal strips are used as sheet metal strips to be welded. The tailor-made sheet metal strip formed of the uncoated sheet metal strips as a result of welding is coated after the welding process.

For example, liquid zinc, aluminium-silicon or anti-corrosion oil is applied as a coating agent to one or both sides of the tailor-made sheet metal strip.

The invention is based on the finding that, during the welding of coated slit strips made of metal materials to form tailored strips, elements and residual material of the coating of the slit strips used infiltrate the weld seam. These seam impurities can lead to premature and undefined failure of the weld seam in the event of shaping or stressing of tailored strips. This problem is reliably solved by the method according to the invention. Sheet metal strips produced by the method according to the invention are characterised by a considerably improved weld seam strength.

An advantageous configuration of the method according to the invention consists in the respective weld seam of the tailor-made sheet metal strip being subjected to local heat treatment by reheating prior to its coating, for example in the case of ferrite stainless steels. As a result of such a local reheating of the weld seam, stress concentrations can be relieved in the weld seam and in the region adjacent thereto, in such a way that the strength of the weld seam is further optimised.

In a further preferred configuration of the method according to the invention the tailor-made sheet metal strip (tailored strip) is temporarily heated over its entire width or over the width of one of its sheet metal strips (slit strips). The microstructure of the tailor-made sheet metal strip is thus homogenized.

The temporary heating process is preferably carried out directly after the welding of the sheet metal strips (slit strips) of different material quality and/or sheet metal thickness in a continuous process. In particular, at least one radiation furnace or at least one induction device can be used for this purpose. The temporary heating of the tailor-made sheet metal strip in a continuous process makes it possible to operate the corresponding production plant continuously and therefore achieve a high level of productivity.

Annealing of a tailor-made sheet metal strip which is rolled up to form a coil is also conceivable, for example in a hood-type annealing furnace.

In a further configuration of the method according to the invention the tailor-made sheet metal strip is cut to length by means of a cutting device and portions, which have been cut to length, of the sheet metal strip are temporarily heated in a furnace. This is expedient compared to an alternative continuously operating configuration of the method according to the invention, in particular if there is insufficient space for the installation of a continuously operating production plant or if there are other space restrictions.

A further advantageous configuration of the method according to the invention consists in carrying out the temporary heating of the tailored strips in an inert gas atmosphere. Scaling of the tailor-made sheet metal strip can thus be prevented.

In a further advantageous configuration the tailor-made sheet metal strip is temporarily heated in the course of a heat treatment during the coating process. In addition to homogenisation of its microstructure, the sheet metal strip can thus be coated simultaneously. An increase in productivity and a space-saving design of the corresponding production plant in terms of plant layout can thus be achieved. Furthermore, the mechanical properties of the tailor-made sheet metal strip can also be adjusted by the heat treatment during the coating process.

A further expedient configuration of the method according to the invention is characterised in that the tailor-made sheet metal strip is cooled after the temporary heating and/or coating. The subsequent handling of the tailor-made sheet metal strip is thus facilitated. In this case, winding devices for example, which are not designed for high temperatures, can thus be used to roll up the tailor-made sheet metal strip.

Further preferred and advantageous configurations of the method according to the invention are disclosed in the dependent claims.

The invention will be described hereinafter in greater detail with reference to drawings which schematically illustrate perspective views of a number of embodiments, and in which:

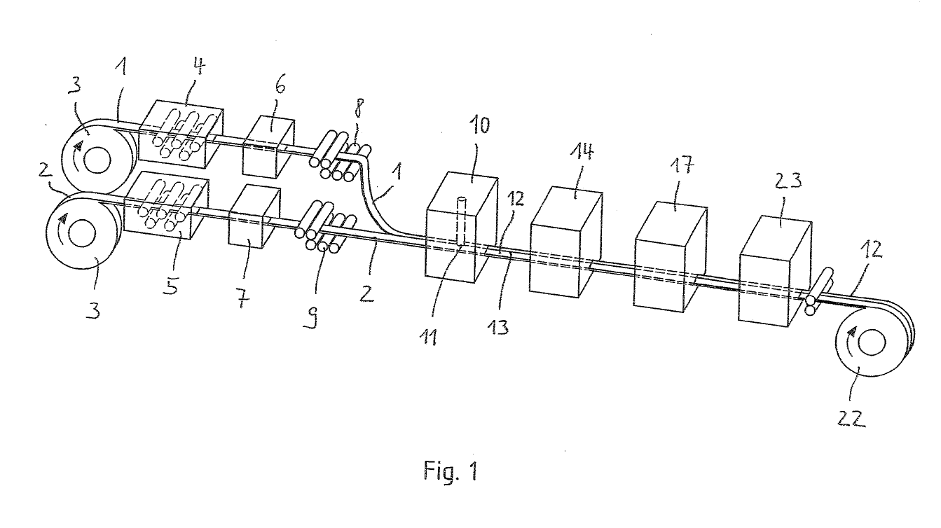

FIG. 1 shows a first embodiment of a device for carrying out the method according to the invention;

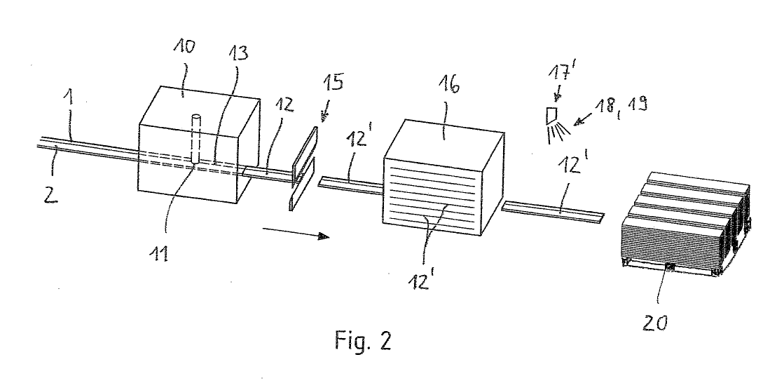

FIG. 2 shows a second embodiment of a device for carrying out a variation of the method according to the invention; and

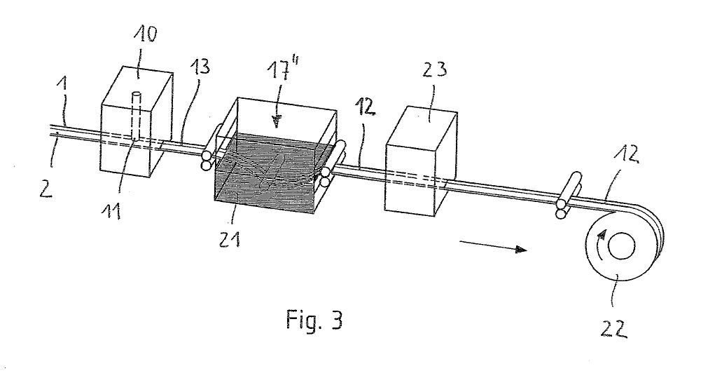

FIG. 3 shows a third embodiment of a device for carrying out a further variation of the method according to the invention.

In order to produce tailored strips, i.e. tailor-made sheet metal strips, in particular steel strips, two, three or more slit strips 1, 2 of different material quality and/or thickness are welded to one another along the longitudinal edge. The slit strips 1, 2 to be welded to one another are uncoated and are provided in the form of coils 3 (see FIG. 1). The individual slit strips or steel strips 1, 2 are first levelled out in separate levelling machines 4, 5 once the respective coil 3 has been unrolled. The edges are then, machined, wherein at least the edges of the slit strips 1, 2 to be welded can be prepared for the subsequent welding process by means of grinding machines and/or milling machines 6, 7.

The slit strips 1, 2 are fed by means of separate conveying means (driver units) 8, 9 and strip guide means, in particular strip guide rollers, to one welding device 10 arranged in succession in the direction of movement of the strip, or, if there are more than two slit strips 1, 2, to a corresponding number of said welding devices reduced by one with respect to the number of slit strips, where they are welded to one another in a continuous process. The slit strips 1, 2 are brought together in such a way that their mutually opposed longitudinal edges can be welded to one another in the manner of a butt joint. However, the slit strips 1, 2 can also be welded to one another in an overlapping manner within the scope of the method according to the invention.

The slit strips 1, 2 are welded to one another continuously. The welding process may be carried out in a different manner, but laser welding is preferably used. The slit strips 1, 2 may, however, also be welded by induction welding.

Shielding gas (inert gas), for example nitrogen gas, is preferably fed to the working point 11 of the welding beam or laser beam in order to prevent oxidation of the weld seam 13. Furthermore, the respective weld seam 13 is subjected to local heat treatment by reheating in order to relieve or at least reduce possible stress concentrations.

The tailor-made sheet metal strip 12 is temporarily heated over its entire width or over the width of one of its sheet metal strips (slit strips) 1, 2, either alternatively or in addition to the reheating of the seam, in order to homogenize the microstructure of the sheet metal strip 12. The sheet metal strip 12 is heated to a temperature in the range of 200° C. to 500° C. The temporary heating is preferably carried out in an inert gas atmosphere.

As illustrated in FIG. 1, the temporary heating may be carried out directly after the welding process in a continuous process. For example, at least one heating device 14, for example a radiation furnace or an induction device, is used for this purpose.

Alternatively to the embodiment illustrated in FIG. 1, the strip 12 formed of the slit strips 1, 2 can also be temporarily heated offline, i.e. separately from the welding process carried out in a continuous process. For this purpose, the tailor-made strip 12 is rolled up by means of a winding device and the coil is then temporarily heated, for example in a hood-type annealing furnace.

A further variation of the method according to the invention in which the temporary heating is carried out offline is illustrated in FIG. 2. The strip 12 formed of the slit strips 1, 2 of different material quality and/or thickness is cut to length by means of a cutting device 15. For example, mechanical separating shears may be used as the cutting device 15. In order to continuously operate the welding devices 10, a strip holding tank (not shown) or the like is arranged upstream of the cutting device 15. The portions 12′, which have been cut to length, of the sheet metal strip 12 are then temporarily heated in a furnace 16, for example a hood-type annealing furnace, in order to standardise the microstructure of the strip portions 12′.

The tailor-made strip 12 or the separated strip portions 12′ is/are coated on one or both sides in a coating device 17, 17′ after the temporary heating (see FIGS. 1 and 2). For example, the coating process is a hot galvanising process, a electrolytic plating process or a hot-dip aluminising process. Alternatively, the coating process may also consist of an application of anti-corrosion oil 18 or protective lacquer 19. Anti-corrosion oil 18 or protective lacquer 19 is applied, for example, by means of a spraying device 17′. A specific number of tailor-made, coated strip portions 12′ are then assembled together or stored on pallets 20 or in pallet cages or the like, ready for despatch.

In a preferred configuration of the method according to the invention the tailor-made strip 12 is temporarily heated in the course of a heat treatment during the coating in a continuous process. This variation is illustrated in FIG. 3. In this case the strip 12 is fed through a coating bath 17″ after the welding process. For example, molten zinc is located in the coating bath container 21; the liquid coating agent having a temperature, for example, in the range of 200° C. to 500° C. Alternatively, heated anti-corrosion oil or liquid, heated protective lacquer may also be poured into the coating bath container 21 as a coating agent. So as to provide the tailor-made strip 12 merely with the necessary amount of the coating agent, excess coating agent is separated off from the strip 12, for example by means of a blowing-off or stripping device (not shown), and is fed back into the coating bath 17″.

So as to facilitate the handling of the tailor-made strip 12 or strip portions 12′ separated off therefrom (see FIG. 2) after the temporary heating and/or coating, the heated strip 12 or the heated strip portions 12′ can be cooled. Such a forced cooling is expedient, in particular, if the strips welded to one another along the longitudinal edge are rolled up to form a coil 22. The temperature of the heated tailor-made strip 12 is reduced by means of a cooling device 23 arranged upstream of the winding device, to such an extent that the winding means is prevented from being subjected to excessively high temperatures. The heated strip 12 is preferably cooled to a temperature below 100° C., in particular below 80° C.

The accomplishment of the invention is not limited to the embodiments described above. Rather, further variations are conceivable which also make use of the invention disclosed in the accompanying claims, even if the design deviates. In particular, it is possible to roll up the tailor-made strip 12 between the welding process and the subsequent coating process, optionally for intermediate storage. It is important that the coils 3 (slit strips 1, 2) to be welded are uncoated and that the coating process is only carried out after welding to form the tailored strips 12.

1. A method for producing tailor-made sheet metal strips comprising welding at least two sheet metal strips of different material quality, sheet metal thickness, or both to one another along a longitudinal edge in a continuous process, wherein uncoated sheet metal strips are used as sheet metal strips to be welded, and coating the tailor-made sheet metal strip formed as a result of welding the uncoated sheet metal strips.

2. The method according to claim 1, wherein a respective weld seam of the tailor-made sheet metal strip is subjected to local heat treatment by reheating prior to coating.

3. The method according to claim 1, wherein the tailor-made sheet metal strip is temporarily heated over its entire width.

4. The method according to claim 1, wherein the tailor-made sheet metal strip is temporarily heated over the width of one of its sheet metal strips.

5. The method according to claim 3, wherein the temporary heating process is carried out directly after the welding of the sheet metal strips of different material quality, sheet metal thickness, or both in a continuous process.

6. The method according to claim 3, wherein the temporary heating is carried out by means of at least one radiation furnace or at least one induction device.

7. The method according to claim 1, further comprising cutting the tailor-made sheet metal strip to length by means of a cutting device and temporarily heating portions, which have been cut to length, of the sheet metal strip in a furnace.

8. The method according to claim 3, wherein the temporary heating is carried out in an inert gas atmosphere.

9. The method according to claim 3, wherein the temporary heating is carried out in the course of a heat treatment during the coating of the tailor-made sheet metal strip.

10. The method according to claim 3, wherein the tailor-made sheet metal strip is cooled after being temporarily heated, coated, or both.

11. The method according to claim 10, wherein the tailor-made sheet metal strip is cooled to a temperature below 100° C., preferably below 80° C.

12. The method according to claim 1, wherein uncoated sheet metal strips are used as sheet metal strips to be welded, and in that the tailor-made sheet metal strip formed of the uncoated sheet metal strips as a result of welding is then coated on one or both sides by a hot galvanising process, an electrolytic zinc-plating process, or a hot-dip aluminising process.

13. The method according to claim 1, wherein the sheet metal strip formed of the uncoated sheet metal strips as a result of welding is coated on one or both sides with a protective lacquer or with anti-corrosion oil.

14. The method according to claim 3, wherein the coating process is carried out with protective lacquer or anti-corrosion oil after the temporary heating.
